(19) United States
(12) Patent Application Publication
(10) Pub. No.: US 2016/0103845 A1
(43) Pub. Date: Apr. 14, 2016

(54) Enhanced Handling Of Intermediate Data Generated During Distributed, Parallel Processing

(71) Applicant: Robin Systems, Inc., Milpitas, CA (US)

(72) Inventors: Krishna Satyasai Yeddanapudi, Pleasanton, CA (US); Gurmeet Singh, Fremont, CA (US); Dhanashankar Venkatesan, San Jose, CA (US)

(21) Appl. No.: 14/877,310

(22) Filed: Oct. 7, 2015

Related U.S. Application Data
(60) Provisional application No. 62/062,072, filed on Oct. 9, 2014.

(51) Int. Cl. G06F 17/30

(52) U.S. Cl. CPC G06F 17/30076; G06F 17/30132

(57) ABSTRACT

Systems and methods are disclosed for reducing latency in shuffle-phase operations employed during the MapReduce processing of data. One or more computing nodes in a cluster of computing nodes capable of implementing MapReduce processing may utilize memory servicing such node(s) to maintain a temporary file system. The temporary file system may provide file-system services for intermediate data generated by applying one or more map functions to the underlying input data to which the MapReduce processing is applied. Metadata devoted to this intermediated data may be provided to and/or maintained by the temporary file system. One or more shuffle operations may be facilitated by accessing file-system information in the temporary file system. In some examples, the intermediate data may be transferred from one or more buffers receiving the results of the map function(s) to a cache apportioned in the memory to avoid persistent storage of the intermediate data.

### RELATED APPLICATIONS

This application claims the benefit of U.S. Provisional Application Ser. No. 62/062,072, filed on Oct. 9, 2014, which is incorporated herein in its entirety.

### FIELD OF THE INVENTION

This invention relates to the processing of large data sets and more particularly to intermediate data and/or operations involved in distributed, parallel processing frameworks, such as MapReduce frameworks, for processing such large data sets.

### BACKGROUND OF THE INVENTION

As the ways in which data is generated proliferate, the amount of data stored continues to grow, and the problems that are being addressed analytically with such data continues to increase, improved technologies for processing that data are sought. Distributed, parallel processing defines a large category of approaches taken to address these demands. In distributed, parallel processing, many computing nodes can simultaneously process data, making possible the processing of large data sets and/or completing such processing within more reasonable time frames. However, improving processing times remains an issue, especially as the size of data sets continues to grow.

To actually realize the benefits of the concept of parallel processing, several issues, such as distributing input data and/or processing that data, need to be addressed during implementation. To address such issues, several different frameworks have been developed. MapReduce frameworks constitute a common class of frameworks for addressing issues arising in distributed, parallel data processing. Such frameworks typically include a distributed file system and a MapReduce engine. The MapReduce engine processes a data set distributed, according to the distributed file system, across several computing nodes in a cluster. The MapReduce engine can process the data set in multiple phases. Although two of the phases, the map phase and the reduce phase, appear in the title of the MapReduce engine, an additional phase, known as the shuffle phase is also involved. The data handled during the shuffle phase provides a good example of intermediate data, generated from input data, but not constituting the final output data, in distributed, parallel processing.

For example, with respect to MapReduce frameworks, the map phase can take input files distributed across several computing nodes in accordance with the distributed file system and can apply map functions to key-value pairs in those input files, at various mapper nodes, to produce intermediate data with new key-value pairs. The reduce phase can combine the values from common keys in the intermediate data, at reducer nodes, from various mapper nodes in the cluster. However, providing these reducer nodes with intermediate data with the appropriate keys being combined at the appropriate reducers can involve additional processing that takes place in the shuffle phase. Although not appearing in the title of a MapReduce framework, the shuffle phase makes possible MapReduce approaches to parallel data processing and, in many ways, can be seen as the heart of such approaches, providing the requisite circulation of data between map nodes and reduce nodes. Intermediate data in other distributed, parallel processing frameworks fulfills similar roles.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not, therefore, to be considered limiting of its scope, the invention will be described and explained with additional specificity and detail through use of the accompanying drawings, in which:

FIG. 1a is a schematic block diagram of a distributed file system consistent with MapReduce frameworks and in accordance with prior art;

FIG. 1b is a schematic block diagram of phases of a MapReduce engine, focusing on map and reduce phases, consistent with MapReduce frameworks and in accordance with prior art;

FIG. 2 is a schematic block diagram of a shuffle phase, potential shuffle operations, and interaction with a file system for intermediate data generated by the map phase, in accordance with prior art;

FIG. 3 is a schematic block diagram of a temporary/shuffle file system devoted to intermediate/shuffle data and maintained in the memory servicing a computing node supporting a mapper and/or metadata being transferred to that temporary/shuffle file system and/or memory; also depicted is interaction with the temporary/shuffle file system for intermediate/shuffle data, enabling the shuffle phase and/or operations in the shuffle phase, in accordance with examples disclosed herein;

FIG. 4 is a schematic block diagram of potential types of information that may be included in metadata provided to a temporary/shuffle file system devoted to intermediate/shuffle data and residing in memory, in accordance with examples disclosed herein;

FIG. 5 is a schematic block diagram of a mapper node implementing a temporary/shuffle file system in concert with a cache apportioned in the memory of a mapper node and operable to receive intermediate/shuffle data, enhancing the accessibility of the data by avoiding direct writes of the intermediate/shuffle data into persistent storage, in accordance with examples disclosed herein;

FIG. 6 is a schematic block diagram of a data center supporting virtual computing nodes involved in the implementation of a MapReduce framework, together with a temporary/shuffle file system supporting the shuffle phase in relation to a virtual computing node and maintained in the memory apportioned to service that virtual computing node, in accordance with examples disclosed herein;

FIG. 7 is a schematic block diagram depicting a sizing module operable to analyze MapReduce jobs sent to a cluster implementing a MapReduce framework and/or to execute one or more approaches to increase the potential for caches, at the various nodes generating intermediate/shuffle data in the cluster, to be able to maintain the intermediate/shuffle data in cache without, or with fewer, writes to persistent storage, in accordance with examples disclosed herein; and

FIG. 8 is a flow chart of methods for reducing latency during the shuffle phase of data processing by maintaining a temporary/shuffle file system both in the memory of a mapper node and devoted to intermediate/shuffle data generated by the mapper and referencing the temporary/shuffle file system to facilitate one or more operations of the shuffle phase, in accordance with examples disclosed herein.

### DETAILED DESCRIPTION

It will be readily understood that the components of the present invention, as generally described and illustrated in the Figures herein, can be arranged and designed in a wide variety of different configurations. Thus, the following more detailed description of the embodiments of the invention, as represented in the figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

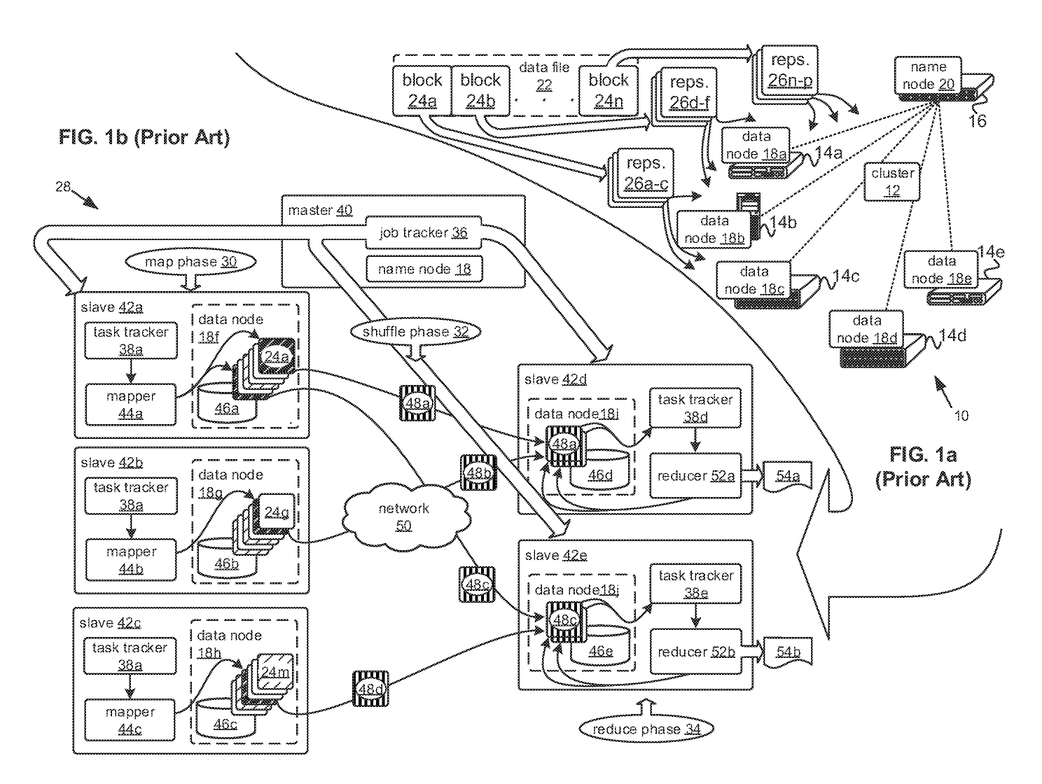

Referring to FIGS. 1a and 1b, examples are depicted consistent with different components of MapReduce frameworks utilized in the prior art. Although the disclosures for handling intermediate data herein may enhance several different types of distributed, parallel processing frameworks, MapReduce frameworks provide a useful example for setting forth such disclosures. Therefore, MapReduce frameworks are briefly described for purposes of discussion below. Whereas FIG. 1a depicts aspects involved in a distributed file system consistent with a MapReduce framework, FIG. 1b depicts aspects of a MapReduce engine also consistent with such a framework.

Referring to FIG. 1a, an Automated, Distributed File System (ADFS) 10 consistent with MapReduce frameworks is depicted. The ADFS 10 may be implemented in software, firmware, hardware, and/or the like as modules, the term module being defined below. Such modules and/or hardware may make up a cluster 12 with various computing nodes 14a-14e, 16. Hardware supporting these computing nodes 14a-14e, 16 may comprise commodity hardware and/or specially purposed hardware. Both data nodes 18a-18e and a name node 20 may be established at the various computing nodes 14a-14e, 16.

The ADFS 10 may be configured to receive a large data file, or data set, 22 and to split the large data set 22 into multiple blocks 24a-24n (also referred to as data blocks) for storage among multiple data nodes 18, increasing the potential available storage capacity of the ADFS 10. To provide redundancy, in case a data node 18 on which a given block 24 is stored fails and/or to provide greater access to the blocks 24, the blocks 24 may be replicated to produce a number of replicas 26a-c, 26d-f, 26n-p of each block 24a, 24b, 24n for storage among the data nodes. (As used in this application, the term block 24 is synonymous with any replica 26 carrying the same data, with the exception of uses of the term block in the context of method flow charts.)

The ADFS 10 may be configured for fault tolerance protocols to detect faults and apply one or more recovery routines. Also, the ADFS 10 may be configured to store blocks/replicas 24/26 closer to more instances of processing logic. Such storage may be informed by a goal of reducing a number of block transfers during processing.

The name node 20 may fill a role as a master server in a master/slave architecture with data nodes 18a-e filling slave roles. Since the name node 20 may manage the namespace for the ADFS 10, the name node 20 my provide awareness, or location information, for the various locations at which the various blocks/replicas 24/26 are stored. Furthermore, the name node 20 may determine the mapping of blocks/replicas 24/26 to data nodes 18. Also, under the direction of the name node 20, the data nodes 18 may perform block creation, deletion, and replica functions. Examples of ADFSs 10, provided by way of example and not limitation may include GOOGLE File System (GFS) and Hadoop Distributed File System (HDFS). As can be appreciated, therefore, the ADFS 10 may set the stage for various approaches to distributed and/or parallel processing, as discussed with respect to the following figure.

Referring to FIG. 1b, aspects of a MapReduce engine 28 are depicted. A MapReduce engine 28 may implement a map phase 30, a shuffle phase 32, and a reduce phase 34. A master/slave architecture, as discussed with respect to the ADFS 10 in terms of the relationship between the name node 20 and the data nodes 18, may be extended to the MapReduce engine 28.

In accordance with the master/slave architecture, a job tracker 36, which also may be implemented as a resource manager and/or application master, may serve in a master role relative to one or more task trackers 38a-e. The task trackers 38a-e may be implemented as node managers, in a slave role. Together, the job tracker 36 and the name node 20 may comprise a master node 40, and individual parings of task trackers 38a-e and data nodes 18f-j may comprise individual slave nodes 42a-e.

The job tracker 36 may schedule and monitor the component tasks and/or may coordinate the re-execution of a task where there is a failure. The job tracker 36 may be operable to harness the locational awareness provided by the name node 20 to determine the nodes 42/40 on which various data blocks/replicas 24/26 pertaining to a data-processing job reside and which nodes 42/40 and/or machines/hardware and/or processing logic are nearby. The job tracker 36 may further leverage such locational awareness to optimize the scheduling of component tasks on available slave nodes 42 to keep the component tasks close to the underlying data blocks/replicas 24/26. The job tracker 36 may also select a node 42 on which another replica 26 resides, or select a node 42 proximate to a block/replica 24/26 to which to transfer the relevant block/replica 24/26 where processing logic is not available on a node 42 where the block/replica 24/26 currently resides.

The component tasks scheduled by the job tracker 36 may involve multiple map tasks and reduce tasks to be carried out on various slave nodes 42 in the cluster 12. Individual map and reduce tasks may be overseen at the various slave nodes 42 by individual instances of task trackers 38 residing at those nodes 42. Such task trackers 38 may spawn separate Java Virtual Machines (JVM) to run their respective tasks and/or may provide status updates to the job tracker 36, for example and without limitation, via a heartbeat approach.

During a map phase 30, a first set of slave nodes 42a-c may perform one or more map functions on blocks/replicas 24/26 of input data in the form of files with key-value pairs. To execute a map task, a job tracker 36 may apply a mapper 44a to a block/replica 24/26 pertaining to a job being run, which may comprise an input data set/file 22. A task tracker 38a may select a data block 24a pertaining to the MapReduce job being processed from among the other blocks/replicas 24/26 in a storage volume 46a used to maintain a data node 18f at the slave node 42a. A storage volume 46 may comprise a medium for persistent storage such as, without limitation a Hard Disk (HD) and/or a Solid State Drive (SSD).

As the output of one or more map functions, a mapper 44 may produce a set of intermediate data with new key-value pairs. However, after a map phase 30, the results for the new key-value pairs may be scattered throughout the intermediate data. The shuffle phase 32 may be implemented to organize the various new key-value pairs in the intermediate data.

The shuffle phase 32 may organize the intermediate data at the slave nodes 42a-42c that generate the intermediate data. Furthermore, the shuffle phase 32 may organize the intermediate data by the new keys and/or additional slave nodes 42d, 42e to which the new key-values are sent to be combined during the reduce phase 34. Additionally the shuffle phase 32 may produce intermediate records/files 48a-48d. The shuffle phase 32 may also copy the intermediate records/files 48a-48d over a network 50 via a Hypertext Transfer Protocol (HTTP) to slave nodes 42d, 42e supporting the appropriate reducers 52a-52b corresponding to keys common to the intermediate records/files 48a-48d.

An individual task tracker 38d/38e may apply a reducer 52a/52b to the intermediate records 48a-b/48c-d stored by the data node 18d/18e at the corresponding slave node 42d/42e. Even though reducers 52 may not start until all mappers 44 are complete, shuffling may begin before all mappers 44 are complete. A reducer 52 may run on multiple intermediate records 48 to produce an output record 54. An output record 54 generated by such a reducer 52 may group values associated with one or more common keys to produce one or more combined values. Due to the way in which individual mappers 44 and/or reducers 52 operate at individual nodes 42/40, the term ‘mapper’ and/or ‘reducer’ may also be used to refer to the nodes 42 at which individual instances of mappers 44 and/or reducers 52 are implemented.

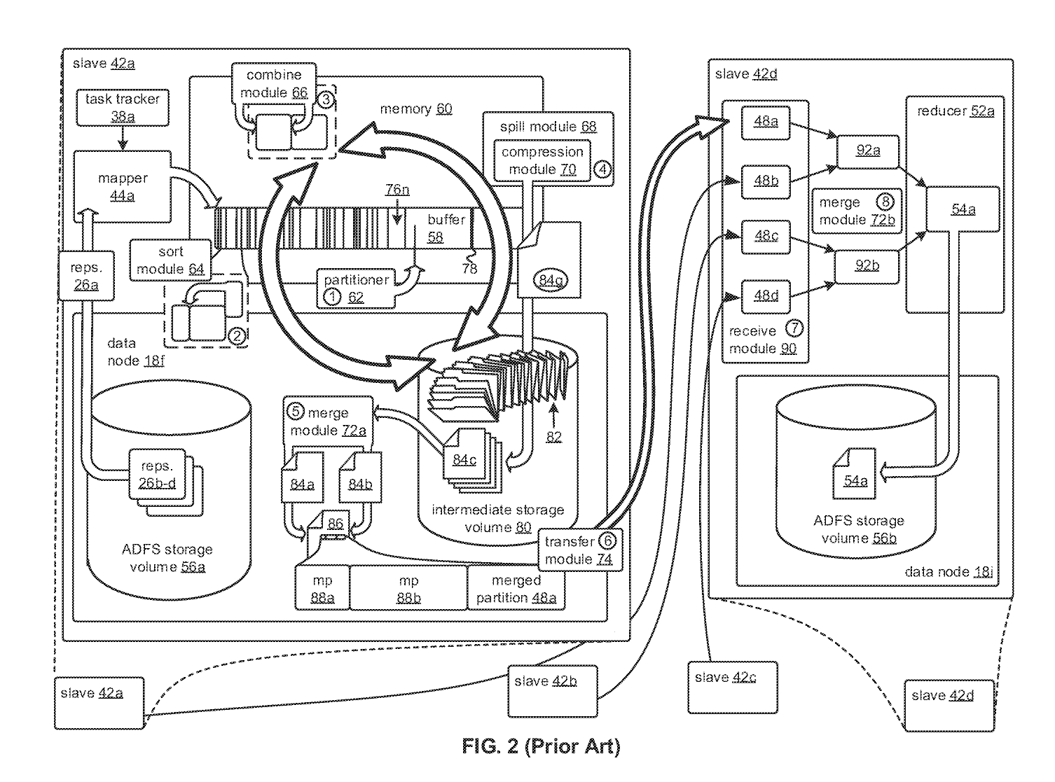

Referring to FIG. 2, Additional aspects of the shuffle phase 32 are depicted. Four of the slave computing nodes 42a-42d depicted in the previous figure are again depicted in FIG. 2. A first expanded view of a first slave node 42a is depicted together with a second expanded view of a fourth slave node 42d. The first slave node 42a may host a task tracker 38a and a mapper 44a. The fourth slave node 42d may host a task tracker 38d and a reducer 52a.

Both the first slave node 42a and the fourth slave node 42d may include an ADFS storage volume 56a, 56b within respective data nodes 18f, 18i. The ADFS storage volume 56a at the first slave node 42a may store one or more blocks/replicas 24/26 assigned to the first slave node 42a by the ADFS 10. The second ADFS storage volume 56b at the fourth slave node 42d may store output 54a from the reducer 52a.

The task tracker 38a and/or the mapper 44a may select the appropriate block/replica 24/26 for a job being processed and retrieve the corresponding data from the first ADFS storage volume 56a. The mapper 44a may process the block/replica 24/26 and place the resultant intermediate data in one or more buffers 58 apportioned from within the memory 60 servicing the first slave computing node 42a.

The first slave node 42a may also support additional modules operable to perform shuffle operations. By way of example and not limitation, non-limiting examples of such modules may include a partition module 62, a sort module 64, a combine module 66, a spill module 68, a compression module 70, a merge module 72, and/or a transfer module 74. As can be appreciated, the modules are numbered 1 through 6. These numbers are provided as a non-limiting example of a potential sequence according to which the corresponding modules may perform their operations for purposes of discussion.

Beginning with the partition module 62, the partition module 62 may divide the intermediate data within the buffer(s) 58 into partitions 76. These portions may correspond to different reducers 52 to which the intermediate data will be sent for the reduce phase 34 and/or different keys from the new key-value pairs of the intermediate data. The presence of such partitions 76 is indicated in the buffer 58 be the many vertical lines delineating different partitions 76 of varying sizes. A relatively small number of such partitions 76 are depicted, but the number of partitions 76 in an actual implementation may easily number in the millions. The partition module 62 is depicted delineating data in the buffer 58 to create just such a partition 76.

Next, the sort module 64 is depicted together with an expanded view of a buffer including three partitions. The sort module 64 may be operable to utilize a background thread to perform an in-memory sort by key(s) and/or relevant reducer 52 assigned to process the key(s) such that partitions 76 sharing such a classification in common are grouped together. Therefore, in the enlarged view of a portion of the buffer 58 appearing under the sort module 64, the right-most partition is depicted as being moved to the left to be located adjacent to the left most partition 76 instead of the larger partition 76 initially adjacent to the left-most partition 76, because of a shared classification. A combination module 66 may combine previously distinct partitions 76, which share a common key(s) and/or reducer 52, into a single partition 76. As indicated by the expanded view showing the former right-most and left-most partitions 76 merged into a single partition 76 on the left-hand side. Additional sort and/or combine operations may be performed.

A spill module 68 may initiate a background thread to spill the intermediate data into storage when the intermediate data output from the mapper 44a fills the buffer(s) 58 to a threshold level 78, such as 70% or 80%. The spilled intermediate data may be written into persistent storage in an intermediate storage volume 80 as storage files 84a-84g. An intermediate file system 82, which may be part of the ADFS 10, or separate, and/or may be devoted to providing file-system services to the storage files 84a-84g. Some examples, include a compression module 70 operable to run a compression algorithm on the intermediate data to be spilled into storage resulting in compressed storage files 84.

Additionally, some examples may include a merge module 72 operable to merge multiple storage files 84a, 84b into a merged storage file 86. The merged intermediate file 48 may include one or more merged partitions 88 sharing a common key and/or reducer 52. In FIG. 2, a first storage file 84a and a second storage file 84b are merged into the merged storage file 86. The merged storage file 86 includes a first merged partition 88a with key-value pairs for a common key and/or reducer 52. Similarly, a second merged partition 88b and a third merged partition 88c may share key-value pairs for a common respective keys and/or reducers 52. As can be appreciated, the number of merged partitions may vary.

A transfer module 74 may make one or more merged partitions 88 available to the reducers 52 over HTTP as an intermediate file/record 48. In some examples, the temporary/shuffle file system may also be transferred and/or received at a node 42 with a reducer 52 to reduce latency for one or more operations at the reducer node 42. A receive module 90 at the fourth slave node 42d may include a multiple copier threads to retrieve the intermediate files 48 from one or more mappers 44 in parallel. In FIG. 2, multiple intermediate files 48a-48d are received from multiple slave nodes 42a-42c with corresponding mappers 44.

Additional intermediate files 48b, 48c, 48d may be received by the fourth slave node 42d. A single mapper, slave node 42 may provide multiple intermediate files 48, as depicted in FIG. 2, which shows the first slave node 42a providing two intermediate files 48a, 48b. Additional intermediate files, such as intermediate files 48c, 48d, may be provided by additional mapper, slave nodes 42, such as mapper, slave nodes 42a, 42b.

In some examples, another instance of a merge module 72b may create merged files 92a, 92b from the intermediate files 48a-48d. The reducer 52a at the fourth slave node 42d may combine values from key-value pairs sharing a common key, resulting in an output file 54a.

As depicted by the pair of large, emboldened, circulating arrows, one or more of the shuffle operations described above may rely on and/or provide information to the intermediate file system 82. As also depicted, however, the intermediate file system 82 is stored within a persistent storage volume 58 residing on one or more HDs, SSDs, and/or the like. Reading information from the intermediate file system 82 to support such shuffle operations, therefore, can introduce latencies into the shuffle phase entailed by accessing information in persistent storage. For example, latencies may be introduced in locating file-system information on a disk, copying the information into a device buffer for the storage device, and/or copying the information into main memory 60 servicing a slave node 42 engaged in shuffle operations. Such latencies may accumulate as shuffle operations are repeated multiple times during the shuffle phase 32.

To overcome such latencies during shuffle-phase operations and/or to provide enhancements while supporting the operations of this phase 32, several innovations are disclosed herein. The following discussion of a system providing a file system for intermediate/shuffle data from distributed, parallel processing provides non-limiting examples of principles at play in such innovations. In such a system, a mapper 44 may reside at a computing node 42 with accompanying memory 60 servicing the computing node 42. The computing node 42 may be networked to a cluster 12 of computing nodes 42, and the cluster 12 may be operable to implement a form of distributed, parallel processing, such as MapReduce processing.

The system may include a temporary file system maintained in the memory 60 of the computing node 42. The temporary file system may be operable to receive metadata for intermediate/shuffle data generated by the mapper 44 at the computing node 42. Such a temporary file system may also be operable to facilitate one or more shuffle operations implemented by MapReduce processing by providing file-system information about the intermediate/shuffle data. By placing the temporary file system in memory 60, speed of access to the file system may be increased, and latencies associated with accessing a file system in persistent storage may be removed.

In some examples, the computing node 42 may maintain a buffer 58 in the memory 60. The buffer 58 may be operable to initially receive the intermediate/shuffle data generated by the mapper 44. Also, in such examples, a page cache may be maintained within the memory 60. A modified spill module may further be provided. The modified spill module may be operable to move intermediate/shuffle data from the buffer to the page cash upon the buffer filling with intermediate/shuffle data to a threshold level. In this way, direct, persistent storage of the intermediate/shuffle data may be avoided.

Certain examples of such systems may include a job store maintained by the cluster 12 of computing nodes 42. The job store may be operable to receive jobs for MapReduce processing in the cluster 12. A sizing module may also be maintained by the cluster 12. The sizing module may be operable to split a job in the job store into multiple jobs.

The smaller jobs may be split by the sizing module to increase a probability that intermediate/shuffle data produced by the computing node 42 in the cluster 12 does not exceed a threshold limit for the page cache maintained by the computing node 42 during processing of one or more of these multiple jobs. In some examples, the sizing module may be operable to increase a number of computing nodes 42 in the cluster 12 of computing nodes 42 processing a given job in the job store, thereby increasing a probability that intermediate/shuffle data does not exceed the threshold limit. Additional options for such systems may include backend storage operable to store intermediate/shuffle data persistently and remotely from the cluster 12 implementing the distributed, parallel processing, such as MapReduce processing. In such examples, a copy of the intermediate/shuffle data in the page cache may be stored in the backend storage to be recovered in the event of node failure.

The foregoing discussions of prior art and the foregoing overview of novel disclosures herein make frequent reference to modules. Throughout this patent application, the functionalities discussed herein may be handled by one or more modules. With respect to the modules discussed herein, aspects of the present innovations may take the form of an entirely hardware embodiment, an entirely software embodiment (including firmware, resident software, micro-code, etc.), or an embodiment combining software and hardware aspects that may all generally be referred to herein as a “module.” Furthermore, aspects of the presently discussed subject matter may take the form of a computer program product embodied in any tangible medium of expression having computer-usable program code embodied in the medium.

With respect to software aspects, any combination of one or more computer-usable or computer-readable media may be utilized. For example, a computer-readable medium may include one or more of a portable computer diskette, a hard disk, a Random Access Memory (RAM) device, a Read-Only Memory (ROM) device, an Erasable Programmable Read-Only Memory (EPROM or Flash memory) device, a portable Compact Disc Read-Only Memory (CDROM), an optical storage device, and a magnetic storage device. In selected embodiments, a computer-readable medium may comprise any non-transitory medium that may contain, store, communicate, propagate, or transport the program for use by or in connection with the instruction execution system, apparatus, or device.

Computer program code for carrying out operations of the present invention may be written in any combination of one or more programming languages, including an object-oriented programming language such as C++, or the like, and conventional procedural programming languages, such as the “C” programming language, or similar programming languages. Aspects of a module, and possibly all of the module, that are implemented with software may be executed on a micro-processor, Central Processing Unit (CPU) and/or the like. Any hardware aspects of the module may be implemented to interact with software aspects of a module.

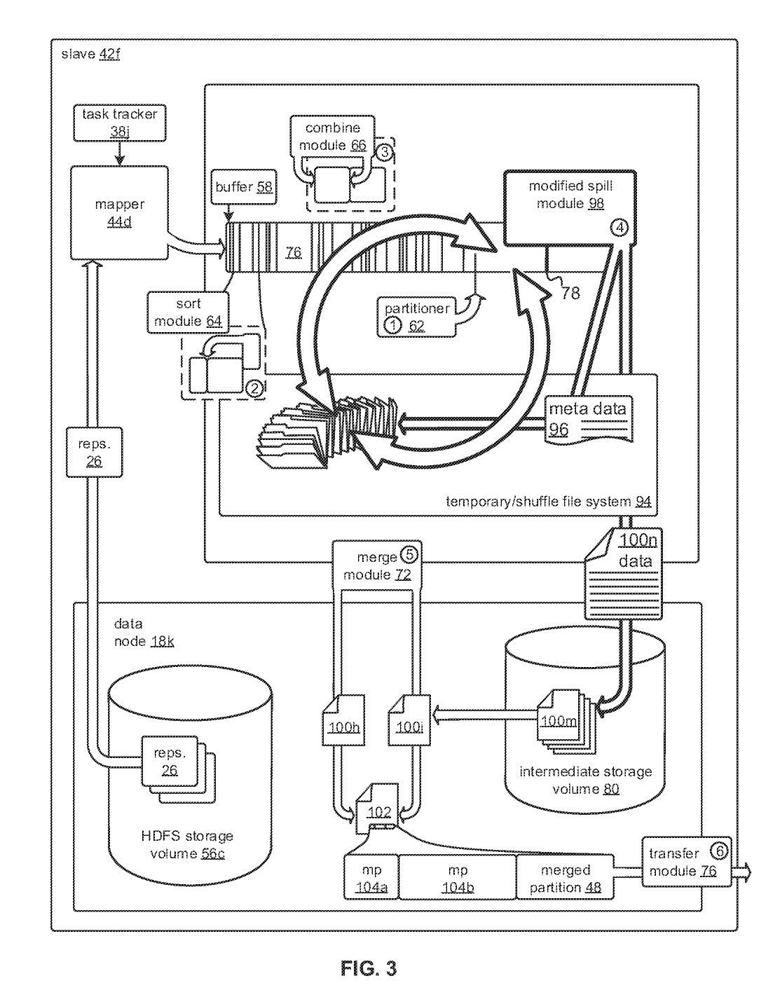

A more detailed disclosure of the innovations set forth above, together with additional, related innovations may now be discussed, together with the relevant modules operable to provide corresponding functionalities. FIG. 3 through FIG. 8 are referenced to aid understanding of these disclosures. The figures referenced in the following discussion are for purposes of explanation and not limitation.

Referring to FIG. 3, a temporary/shuffle file system 94 is depicted. The temporary file system 94 may be maintained in the memory 60 of a slave computing node 42f. Also, the temporary/shuffle file system 94 may be devoted to intermediate/shuffle data generated by a mapper 44d controlled by a task tracker 38j at the slave node 42f. Throughout this patent application, the adjectives ‘temporary’ and/or ‘intermediate’ may be used to indicate general applicability to distributed, parallel processing frameworks for the disclosures herein. The adjective ‘shuffle’ demonstrates applicability of the disclosures herein, in particular, to MapReduce frameworks and/or a shuffle phase therein 32.

There are several reasons why approaches placing a temporary/shuffle file system 94 in memory 60 have not previously been considered. Indeed, for such reasons, previous work has steered in the direction of not only placing intermediate data and file systems pertaining thereto into persistent storage, but replicating such data for persistent storage on multiple nodes 42. A discussion of these reasons may be facilitated by a definition of the term intermediate data. Intermediate data, for purposes of this patent application, includes data generated by a distributed parallel approach to data processing from input data, such as input data blocks/replicas 24/26, including output data/files 54 from a reduce phase 34 that becomes the input for additional parallel processing 28, but excluding ultimate output data/files 54 that are not subject to additional, parallel processing. Intermediate data may, therefore, be processed by multiple operations, such as multiple shuffle operations, while maintaining its status as intermediate data. Shuffle data refers to intermediate data particularly within the context of MapReduce frameworks.

The shuffle phase 32 may commonly overlap the map phase 30 in a cluster 12. One reason for such overlap may include the processing of multiple input blocks/replicas 24/26 by some mappers 44, a common occurrence, and different mappers 44 may process different numbers of blocks/replicas 24/26. Additionally, different input blocks/replicas 24/26 may process at different speeds. Also, a shuffle phase 32 may follow an all-to-all communication pattern in transferring the output from mappers 44 at their corresponding slave nodes 42 to reducers 52 at their respective nodes 42. Therefore, a loss of intermediate data at one node 42 may require the intermediate data to be regenerated for multiple input blocks/replicas 24/26. A renewed shuffle phase 32 may be required after the lost intermediate data is regenerated. Also reduce operations for the intermediate data from the failed node 42 at a reducer, slave node 42 may need to be run again.

Additionally, many applications of parallel data processing may chain together multiple stages such that the output of one stage becomes the input for a following stage. For example, with respect to MapReduce framework, multiple MapReduce jobes may be chained together in multiple stages in the sense that a first job may be processed according to a first MapReduce stage by passing through a map phase 30, a shuffle phase 32, and a reduce phase 34 to produce one or more output file 54 that become the input for a second job, or stage, similarly passing through the various phases of the MapReduce framework.

Similarly, some operations within a common phase may be interdependent on one another, such as examples where the ChainMapper class is used in implement a chain of multiple mapper classes such that the output of a first mapper class becomes the input of a second mapper class and so on. Examples of chained MapReduce frameworks, such as the twenty-four stages used in GOOGLE indexing and the one-hundred stages used in YAHOO's WEBMAP, are fairly common.

Multiple stages, however, can exacerbate problems of lost intermediate/shuffle data and/or access thereto through a corresponding file system. Where each stage feeds off a previous stage, a loss at a later stage may require each earlier stage to reprocess data to re-provide the requisite intermediate data as input data to the later stage. Furthermore, considering the large number of slave nodes 42 involved in many MapReduce frameworks, often numbered in the thousands to tens of thousands, failures at one or more nodes can be fairly common. In 2006, for example, GOOGLE stated an average of five failures per MapReduce job.

Although the redundancy provided by an RDFS 10 and/or by replicas 26 spread across multiple nodes 42 provide means with which to recover from such faults, for the reasons set forth above, such recovery measures may tax resources and introduce significant latency. Therefore, previous investigations into non-persistent, temporary/shuffle file systems for intermediate data and/or non-persistent temporary storage of intermediate/shuffle data have been, to a degree, de-incentivized. To the contrary, several approaches have not only relegated intermediate data and file systems devoted to such data to persistent storage, but have gone further to replicate intermediate data on multiple modes 42 to prevent a need for regeneration in the event of a failure.

However, in the face of such obstacles, advantages, especially in terms of reduced latencies associated with interacting with an intermediate file system 82 in persistent storage, may be obtained by bringing access to intermediate/shuffle data closer to processing logic in the memory 60 servicing a computing node 42. Hence, as depicted in FIG. 3 and as consistent with examples disclosed herein, a temporary/shuffle file system 94 may be maintained in memory 60, such as Random Access Memory (RAM), where it can be accessed by shuffle operations at speeds achievable by such memory 60.

A system consistent with the one depicted in FIG. 3 may be used for reducing latency in a shuffle phase 32 of MapReduce data processing. The depicted slave node 42f may reside within a cluster 12 of nodes 42, where the cluster 12 is operable to perform MapReduce data processing. Memory 60, such as RAM, at the slave node 42f may support computing at the slave node 42. The subject of such computing operations may be obtained from a data node 18k residing at the slave node 42f. The data node 18k may comprise one of more storage devices 56c, which may be operable to provide persistent storage for a block/replica 24/26 of input data for MapReduce data processing. Such input data may have been distributed across the cluster 12 in accordance with a disturbed file system, such as and ADFS 10.

A mapper 44d residing at the slave node 42f may be operable to apply one or more map functions to the block/replica 24/26 of input data resulting in intermediate/shuffle data. The mapper 44d may access an input data-block/replica 24/26 from an HDFS storage volume 56c for a data node 18k maintained by the slave node 42f. One or more buffers 58 apportioned from and/or reserved in the memory 60 may receive the intermediate/shuffle data from the mapper 44d as it is generated. As stated above, an intermediate/shuffle file system 94 may be operable to be maintained at the memory 60. The intermediate/shuffle file system 94 may provide file-system services for the intermediate/shuffle data and/or to receive metadata 96 for the shuffle data.

Once the mapper 44d generates intermediate/shuffle data, several operations associated with the shuffle phase 32 may execute. One or more modules may be operable to perform an operation consistent with a shuffle phase 32 of MapReduce data processing, at least in part, by accessing the temporary/shuffle file system 94. The modules depicted in FIG. 3 are provided by way of example and not limitation. Similarly the numbers assigned to such modules are provided for purposes of discussion and enumerating a potential order in which such modules may perform shuffling operations, but different orderings are possible. Furthermore, such modules may overlap in the performance of shuffle operations and may be repeated multiple times in the same or differing orders.

Non-limiting examples of these modules may include a partition module 62, a sort module 64, a combine module 66, a modified spill module 98, a compression module 70, a merge module 72, and/or a transfer module 74. Such modules may perform shuffle operations similar to those discussed above with respect to FIG. 2. For example, and without limitation, the partition module 62 may be operable to partition intermediate data, as indicated by the vertical partition lines dividing up the buffer 58, into partitions 76. Such partitions 76 may correspond to reducers 52, at computing nodes 42 to which the partitions 76 are copied during the MapReduce processing, and/or to keys in the intermediate/shuffle data.

The sort module 64 may be operable to sort the intermediate/shuffle data by the partitions 76 such that partitions 76 with like reducers 52 and/or keys may be addressed adjacent to one another. The combine module 66 may be operable to combine intermediate/shuffle data assigned a common partition 76, such that multiple partitions 76 with common reducers 52 and/or keys may be combined into a single partition 76.

The modified spill module 98 will be discussed in greater detail below. The merge module 72 may be operable to merge multiple files 98 of intermediate data moved from the buffer 58. The transfer module 74 may be operable to make intermediate data organized by partitions 76 available to corresponding reducers 52 at additional computing nodes 42 in the cluster 12.

However, as opposed to interacting with an intermediate file system 82 in persistent storage, one or more of these modules may interact with the temporary/shuffle file system 94 maintained in memory 60, as indicated by the large, emboldened, circulating arrows. Viewed from another perspective, the temporary/shuffle file system 94 may be operable to provide, at a speed enabled by the memory 60, file-system information about the intermediate/shuffle data. The file-system information may be used to facilitate one or more shuffle operations undertaken by the partition module 62, the sort module 64, the combine module 66, the modified spill module 98, the compression module 70, the merge module 72, and/or the transfer module 74. Since file-system information is stored in memory 60, such shuffle operations may avoid latencies, and/or demands on a Central Processing Unit (CPU), associated with retrieving file-system information from persistent storage.

As with the spill module 68 discussed above with respect to FIG. 2, the modified spill module 98 may be operable to move intermediate/shuffle data from a buffer 58 filled to a threshold limit 78. The modified spill module 98 may store the previously-buffered intermediate/shuffle data as files 98h-n. The modified spill module 98 may store these files 100h-n persistently, in some examples, in an intermediate storage volume 80.

By way of example and not limitation, as can be appreciated, in merging such files 100h, 100i into a common file 102, the merge module 72 may rely on the temporary/shuffle file system 94 to access files 100 for merging. Additionally, the merge module 72 may provide information to the temporary/shuffle file system 94 about newly merged files 102 it may create. Interaction with the temporary/shuffle file system 94 for such shuffle operations may reduce latencies that would be present should an intermediate file system 82 be stored persistently.

A newly merged file 102 may be segregated in terms of merged partitions 104a-104c. Each merged partition 140 may maintain key-value pairs for one or more different keys and/or a corresponding reducer 52. In some examples, an intermediate file 48 transferred to a slave reducer node 42 during the shuffle phase 32 may comprise a single merged partition 104. In other examples, an intermediate file 48 may comprise multiple merged partitions 104. The transfer module 74 may package and/or make available the intermediate file 48 to a reducer node 42 in a one-to-one communication pattern.

The intermediate storage volume 80 may pertain to the HDFS storage volume 56c or be independent therefrom. As an example of another module not depicted herein, a compression module 70 may be included to compress intermediate/shuffle data in files 100 and/or at other portions of the shuffle phase 32. As can be appreciated, the modified spill module 98 may rely upon and/or contribute to the temporary/shuffle file system 94 to package and/or store these files 100h-n.

In persistent storage, such files 100h-n might be used in the event of certain types of failure at the hosting slave node 42f. To enable access to such files 102h-n in the event of a failure resulting in a loss of a temporary/shuffle file system 94, such as due to a loss of power within the memory 60, a copy of the shuffle file system 94 may also be duplicated in persistent storage at the node 42f. Although the duplicated copy may be avoided for purposes of shuffle operations, it may be useful as a backup pathway providing access to the intermediate/shuffle data in the event of a failure.

By way of example and not limitation, as can be appreciated, in merging such files 100h, 100i into a common file 102, the merge module 72 may rely on the temporary/shuffle file system 94 to access files 100 for merging. Additionally, the merge module 72 may provide information to the temporary/shuffle file system 94 about the newly merged files 102 it may create. Interaction with the temporary/shuffle file system 94 for such shuffle operations may reduce latencies that would be present should an intermediate file system 82 be stored persistently.

Not only may the modified spill module 98 be operable to move previously buffered intermediate/shuffle data from the buffer 58 to the temporary/shuffle file system 94, but the modified spill module 98 may also be operable to provide metadata 96 devoted to the buffered shuffle data to the shuffle file system 96. Such metadata 96 may provide file-system information that may facilitate one or more shuffle operations. Owing to the demands placed upon the memory 60, such as, without limitation, demands to apply mapping functions and/or to perform shuffle operations, the shuffle-file-system/temporary-file-system 96 may be simplified to be very light weight. In accordance with such principles of reducing memory usage, the modified spill module 98 may be operable to provide metadata 96 devoted to the shuffle data in categories limited to information utilized by one or more predetermined shuffle operations implemented by the MapReduce data processing.

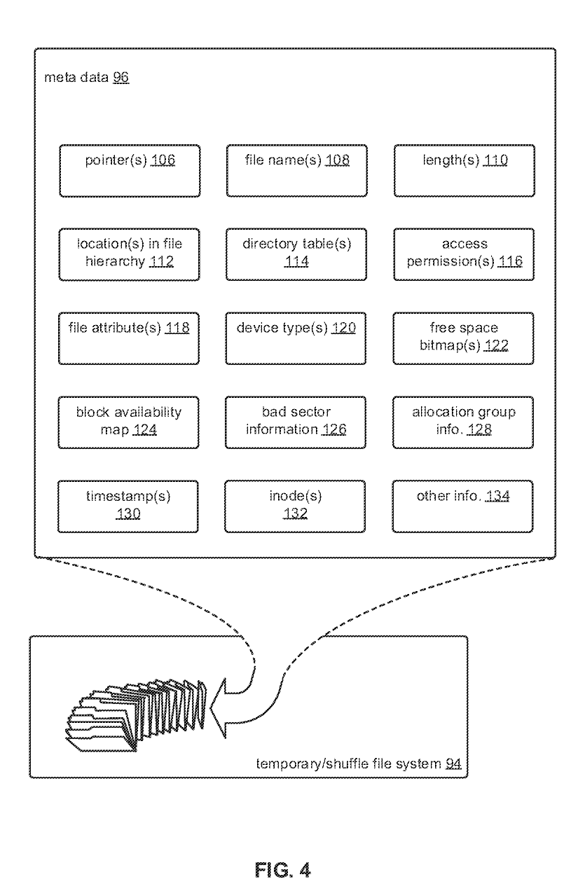

Referring to FIG. 4, classes and/or types of metadata 96 with potential types of information that may be included in metadata 96 are depicted. Such types of metadata 96, some subset thereof, and/or additional types of metadata 96 may be provided to the temporary/shuffle file system 94. Non-limiting examples of metadata 96 may include one or more pointer(s) 106 providing one or more addresses in memory 60 where intermediate/shuffle data may be found, as discussed below.

One or more file names 108 used by the temporary/shuffle file system 94 for files 100/102/48 of intermediate/shuffle data may be included. One or more lengths 110 of such files 9100/102/48 and/or other intermediate/shuffle data may provide another example. Yet another example may include one or more locations in the file hierarchy 112 for one or more files 100/102/48. Structural data, such as one or more tables 114, columns, keys, and indexes may be provided.

Metadata 96 may be technical metadata, business metadata, and/or process metadata, such as data types and or models, among other categories. One or more access permission(s) 116 for one or more files 100/102/48 may constitute metadata 96. One or more file attributes 118 may also constitute metadata 96. For persistently stored data, information about one or more device types 120 on which the data is stored may be included. Also, with respect to persistent storage, metadata 96 may include one or more free-space bit maps 122, one or more block availability maps 124, bad sector information 126, and/or group allocation information 128. Another example may include one or more timestamps 130 for times at which data is created and/or accessed.

Some examples may include one or more inodes 132 for file-system objects such as files and/or directories. As can be appreciated, several other types of information 134 may be included among the metadata 96. The foregoing is simply provided by way of example, not limitation, to demonstrate possibilities. Indeed, several forms of metadata 96 not depicted in FIG. 4 are included in the foregoing. However, as also discussed, in several examples, inclusion if metadata may be very selective to reduce the burden on memory 60. For example, categories of file-system information maintained by the temporary file system 94 may be limited to categories of information involved in supporting a shuffle operation facilitated by the temporary file system 94. An additional potential burden on memory 60 is discussed with respect to the following figure.

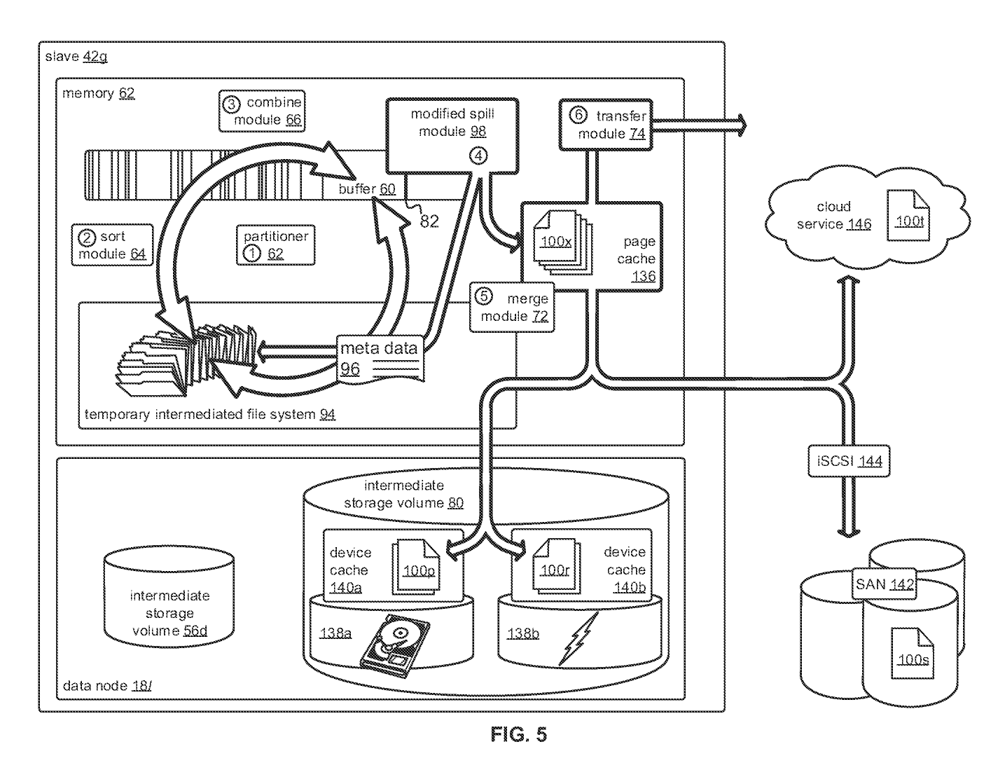

Referring to FIG. 5, a cache 136 for intermediate/shuffle data is depicted. The cache 136, which may be a page cache 136, may reside at a slave node 42g. The slave node 42g may also include a data node 18l, which may in some examples, but not all examples, include an intermediate storage volume 80.

Again, a buffer 58 may be reserved in the memory 60 to receive intermediate/shuffle data from the mapper 44. The cache 136, such as a page cache 136, may also be apportioned from the memory 60. The cache 136 may be operable to receive intermediate/shuffle data from the buffer 58, thereby avoiding latencies otherwise introduced for shuffle-phase execution 32 by accessing shuffle data stored in persistent storage and/or writing intermediate/shuffle data to persistent storage. The modified spill module 98 may be operable to copy intermediate/shuffle data, as a buffer limit 78 is reached, from the buffer 58 to the cache 136 for temporary maintenance and rapid access. In examples where the cache 136 comprises a page cache 136, the size of any unutilized data may be utilized for the cache page 1436 to increase an amount of intermediate/shuffle data that may be maintained outside of persistent storage.

Regardless of additional memory 60 that may be devoted to the cache 136 other allocations of memory 60 to address additional operations and the overarching limitations on the size of memory 60 may keep the size of the cache 136 down. With respect to small data processing jobs, the page cache 136 may be sufficient to maintain the intermediate/shuffle data without recourse to transfers of data elsewhere. Since the amount of intermediate/shuffle data associated with these small jobs is itself relatively small, the likelihood of failures is reduced, such that advantages of reduced latencies may overcome the risks for not storing data persistently. Regardless, the redundancy inherent to an ADFS 10, MapReduce frameworks, and the replicas 26 at different nodes 42 for the underlying input of a job can always be called upon to regenerate intermediate/shuffle data. In scenarios involving such a cache 136, intermediate/shuffle data may be organized in files 100x-100t. Since files 100x-100t for intermediate/shuffle data maintained in the cache 136 are in memory 60, they can be placed in the cache 136 and/or accessed quickly for shuffle operations and/or quickly transferred to reducers 52.

In some examples, the file-system services for the intermediate/shuffle data in the cache 136 may be provided by an intermediate file system 82 in persistent storage. In other examples, file-system services may be provided by a temporary/shuffle file system 94 maintained in memory 60, similar to the one discussed above with respect to FIG. 3. In these examples, such as the one depicted in FIG. 5, latencies may be avoided for shuffle phase 32 interactions with the temporary/shuffle file system 94 and latencies may be avoided with respect to operations on the underlying intermediate/shuffle data, resulting in enhancements to the shuffle phase 32 on two fronts.

In examples involving both a cache 136 and a temporary/shuffle file system 94 in memory, the modified spill module 98 may provide, to the temporary/shuffle file system 94, one or more pointers 106, in the metadata 96, with addresses in memory 60 for the files 100 of intermediate/shuffle data in the cache 136. There may be situations in which the buffer 58 and cache 136 in memory 60 are not sufficiently large for the intermediate/shuffle data. Therefore, some examples may include an intermediate storage volume 80 in the data node 18l.

The intermediate storage volume 80 may comprise one or more storage devices 138. A storage device 138a, 138b at the computing node 42g may be operable to store data persistently and may be a hard disk 138a, an SSD 138b, or another form of hardware capable of persistently storing data. In such examples, the modified spill module 98 may be operable to transfer intermediate/shuffle data from the cache 136 to the intermediate storage volume 80.

A storage device 138 may maintain a device buffer 140. One or more device buffers 140a, 140b may be operable to maintain intermediate/shuffle data for use in one or more shuffle operations implemented by the MapReduce processing. Such a device buffer 140 may be controlled, such as by way of example and not limitation, by an operating system of the computing node 42g to avoid persistent storage of the immediate/shuffle data on the storage device 138 until the intermediate data fills the device buffer 140 to a threshold value. Although the device buffer may not provide as rapid access to intermediate/shuffle data as the cache 136 in memory 60, it may provide less latency than would accrue in scenarios where such data is actually written to the persistent medium of a storage device 144.

In some examples, backend storage may be included in a system. The backed storage may be operable to store intermediate/shuffle data remotely. A non-limiting example of backend storage may include a Storage Area Network (SAN) 142. A SAN 142 may be linked to the slave node 42 by an internet Small Computer System Interface (iSCSI) 144. Another non-limiting example may be a cloud service 146, such as YAHOO CLOUD STORAGE.

The backend storage may be located outside the cluster 12. The modified spill module 98 may store files 100 directly on the backend and/or may store files 100 on the backend after copying the files 100 to the cache 136. In some examples, the modified spill module 98 may begin to store duplicates of files 100 and/or a duplicate to the backend. Files stored in the backend may be recovered in the event of a failure at the computing node 42g.

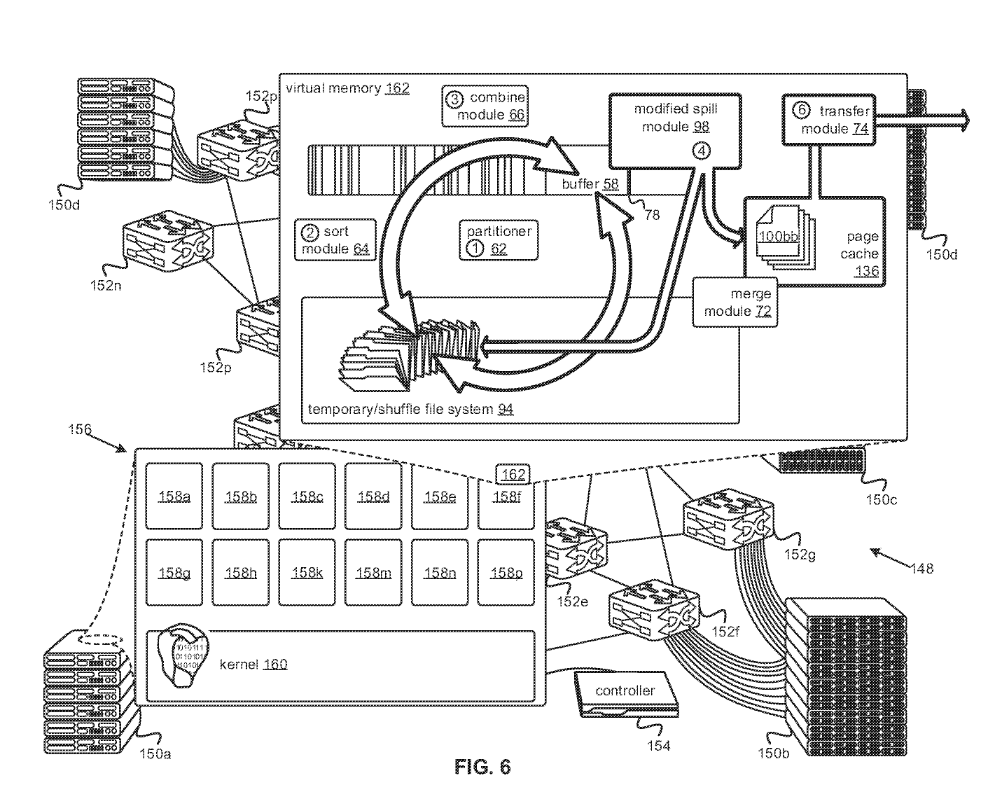

Referring to FIG. 6, a data center 148 is depicted. The data center 148 may include multiple sets 150a-150e of computing systems within an overarching computer system that makes up a data center 148. The data center 148 may include several network nodes 152a-152n. Although the network nodes 152a-152n are depicted in an east-west configuration, other configurations may be used. Also, a controller 154 is depicted, which may be included to support applications, such as MapReduce approaches, that rely on such a centralized computing system 154 for the master node 40.

Also depicted is a virtual computing environment 156, consistent with some examples, with one or more virtual computing nodes 158a-158p. In such examples, a computing system within a set of computing nodes 150a-150g may support the virtual computing environment 156. As can be appreciated, the virtual computing environment 156 depicted in FIG. 6 does not include a hypervisor, consistent with, for example, an Operating-System (OS)-virtualization environment. Therefore, a common kernel 160 may support multiple virtual computing nodes 158a-158p. However, in alternative virtual computing environments incorporating a hypervisor, such as a type-one or a type-two hypervisor, one or more individual virtual computing nodes 158 may be provided with an individual guest operating system, with a kernel 160 specific to the corresponding virtual computing node 158.

One or more of the virtual computing nodes 158a-158p may be allocated virtual memory 162 supported by underlying physical memory 60. In such situations, a temporary/shuffle file system 94 and/or a cache 136 may be maintained in the virtual memory 162 and may be operable to perform functions similar to those discussed above. Similarly, a virtual computing node 158 may be provided with a modified spill module 98 operable to fill roles along the lines of those discussed above. Furthermore, one or more modules operable to perform shuffle operations, along lines discussed above, may also be provided with a virtual computing node 158.

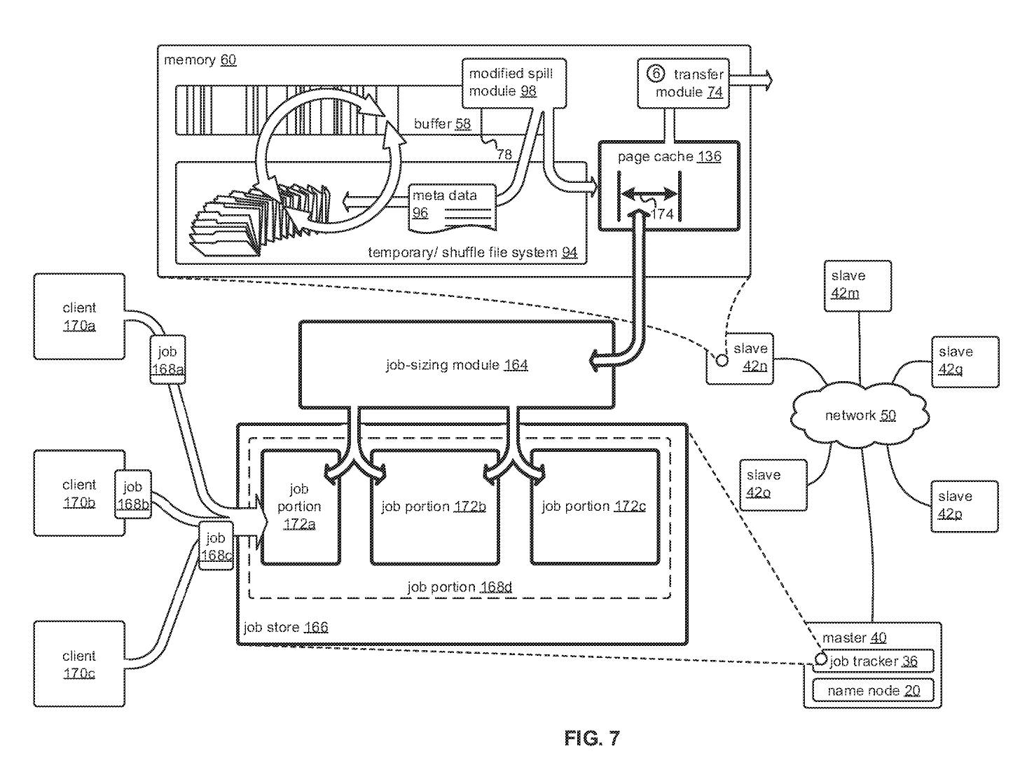

Referring to FIG. 7, a sizing module 164 is depicted. As discussed above, in examples involving a cache 136 in memory 60, it may be advantageous to process jobs where the resultant intermediate/shuffle data will be small enough to fit in one or more caches 136 throughout the cluster 12. The sizing module 164 may assist to increase the probability of such favorable scenarios.

In some examples, the master node 40 in the cluster 12 may maintain a job store 166, such as, without limitation, in a job tracker 36. In some examples, the job store 166 may be stored elsewhere in the cluster 12 and/or in a distributed fashion. The job store 166 may be operable to receive jobs 168a-168d from one or more client devices 170a-170d. Such client devices 170 may reside outside of the cluster 12. The jobs 168 may be for MapReduce data processing in the cluster 12.

The sizing module 164, or job-sizing module may 164, may also reside at the master node 40, elsewhere in the cluster, and/or be distributed in multiple locations. The job-sizing module 164 may be operable split a job 172 to increase a probability that intermediate/shuffle data generated by one or more nodes 42 in the cluster 12 does not exceed a threshold value 174 for the data maintained therein. In some examples, the sizing module 164 may be operable to determine the size 174 of one or more caches 136 at corresponding slave nodes 42 in the cluster 12 and/or the size of input blocks/replicas 24/26 to gauge sizes for job portions 172a-172c into which the sizing module 164 may split a job 168d. Sizes of input blocks/replicas 24/26 may be obtained from the name node 20. In other examples, the sizing module 164 may simply rely on an estimate.

In the alternative, or in combination with a splitting approach, the sizing module 164 may increase a number of nodes 42 participating in the cluster 12 for the processing of a given job 168 in the job store 166. Such approaches may require a framework that supports the dynamic creation of such nodes 42. By increasing the number of participating nodes 42, the sizing module 164 may decrease the size of intermediate/shuffle data generated at nodes 42, thereby increasing a probability that intermediate/shuffle data generated by one or more nodes 42 does not exceed a corresponding threshold value 174 for a corresponding page cache 136. Such approaches may also reduce the risks associated with failures at nodes 42 by reducing the duration of processing at individual nodes 42.

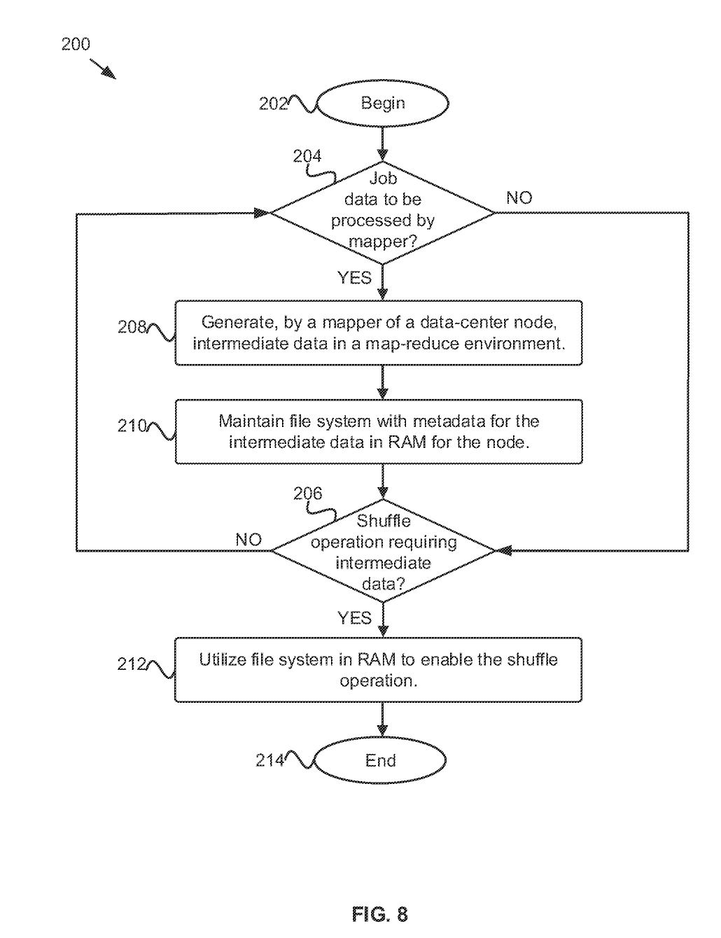

Referring to FIG. 8, methods 200 are depicted for enhancing intermediate operations and/or shuffling operations on intermediate data generated by MapReduce processing. The flowchart in FIG. 8 illustrates the architecture, functionality, and/or operation of possible implementations of systems, methods, and computer program products according to certain embodiments of the present invention. In this regard, each block in the flowcharts may represent a module, segment, or portion of code, which comprises one or more executable instructions for implementing the specified logical function(s). It will also be noted that each block of the flowchart illustrations, and combinations of blocks in the flowchart illustrations, may be implemented by special purpose hardware-based systems that perform the specified functions or acts, or combinations of special purpose hardware and computer instructions.

Where computer program instructions are involved, these computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block-diagram block or blocks.

These computer program instructions may also be stored in a computer readable medium that may direct a computer or other programmable data processing apparatus to function in a particular manner, such that the instructions stored in the computer-readable medium produce an article of manufacture including instruction means which implement the function/act specified in the flowchart and/or block-diagram block or blocks.

The computer program may also be loaded onto a computer or other programmable data processing apparatus to cause a series of operation steps to be performed on the computer or other programmable apparatus to produce a computer implemented process such that the instructions which execute on the computer or other programmable apparatus provide processes for implementing the functions/acts specified in the flowchart and/or block-diagram block or blocks.

Methods 200 consistent with FIG. 8 may begin 202 and a determination 204 may be made as to whether data pertaining to a job 168 to be processed, such as, without limitation, by a mapper 44, is present. If the answer is NO, methods 200 may proceed a determination 206 as to whether an intermediate operation, such as, without limitation, a shuffle operation, requires intermediate/shuffle data. If the answer to the operation determination 206 is again NO, methods may return to the job-data determination 204.

When the job-data determination 204 is YES, such methods 200 may generate 208, by the mapper 44 where applicable, intermediate/shuffle data for distributed, parallel processing, such as, without limitation, MapReduce processing. The memory 60 of a computing node 42 may maintain 210 a temporary/shuffle file system 94 for intermediate data produced at the computing node 42 during distributed, parallel processing, such as, without limitation, MapReduce processing, by the cluster 12 of computing nodes 42. Additionally, a modified spill module 98 may provide metadata 96 about the intermediate data to the temporary/shuffle file system 94.

Methods 200 may then encounter the operation determination 206. Where the answer to this determination 206 is NO, methods may return to the job-data determination 204. Where the answer to the soperation determination 206 is YES, methods 200 may reference/utilize 212 the temporary/shuffle file system 94 to support/enable one or more intermediate and/or shuffle operations implemented by the distributed, parallel processing, and/or MapReduce processing, at a speed consistent with the memory 60 maintaining the temporary/shuffle file system 94 before such methods 200 end 214.

Some methods 200 may further entail moving intermediate/shuffle data from a buffer 58 to a cache 136 maintained by the memory 60 of a computing node 42. In memory 60, such data may be available for temporary accessibility. Additionally, delays associated with persistent storage may be avoided.

Certain methods 200 may be initiated upon receiving a job 168 from a client device 170. The job 168 may be received by the cluster 12 of computing nodes 42. Such methods 200 may further involve splitting, at a master computing node 40 in the cluster 12 where applicable, the job 168 into multiple smaller jobs 172. These smaller jobs 172 may reduce the potential for maxing out the cache 136 and for one or more writes of intermediate/shuffle data into persistent storage for one or more smaller jobs 172 from the multiple smaller jobs 172.

It should also be noted that, in some alternative implementations, the functions noted in the blocks may occur out of the order noted in the figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are embraced within their scope.

1. A system providing a file system for intermediate data from MapReduce processing:
a mapper residing at a computing node, the computing node networked to a cluster of computing nodes, the cluster operable to implement MapReduce processing;
memory servicing the computing node;
a temporary file system maintained in the memory and operable to receive metadata for intermediate data generated by the mapper; and
the temporary file system operable to facilitate at least one shuffle operation implemented by the MapReduce processing by providing file-system information about the intermediate data.

2. The system of claim 1, further comprising:
a buffer maintained in the memory and operable to initially receive the intermediate data generated by the mapper;
a page cache maintained within the memory; and
a modified spill module operable to move intermediate data from the buffer to the page cash upon the buffer filling with intermediate data to a threshold level, thereby avoiding direct, persistent storage of the intermediate data.

3. The system of claim 2, further comprising backend storage operable to store intermediate data persistently and remotely from the cluster implementing the MapReduce processing.

4. The system of claim 2, further comprising:
a storage device at the computing node and operable to store data persistently;
a device buffer maintained by the storage device and operable to maintain intermediate data for use in the at least one shuffle operation implemented by the MapReduce processing to avoid persistent storage of the immediate data on the storage device until the intermediate data fills the device buffer to a threshold value.

5. The system of claim 2, further comprising:
a job store maintained by the cluster of computing nodes and operable to receive jobs for MapReduce processing in the cluster;
a sizing module also maintained by the cluster and operable to split a job in the job store into multiple jobs, increasing a probability that intermediate data produced by the computing node in the cluster does not exceed a threshold limit for the page cache, maintained by the computing node, during processing of at least one of the multiple jobs.

6. The system of claim 2, further comprising:
a job store maintained by the cluster of computing nodes and operable to receive jobs for MapReduce processing in the cluster of computing nodes; and
a sizing module also maintained by the cluster and operable to increase, in the cluster, a number of computing nodes processing a given job in the job store, increasing a probability that intermediate data does not exceed a threshold the for the page cache, maintained by the computing node, during processing of the given job.

7. The system of claim 1, further comprising
at least one of:
a partition module operable to partition intermediate data into partitions corresponding to reducers at computing nodes to which the partitions are copied during the MapReduce processing;
a sort module operable to sort the intermediate data by the partitions;
a combine module operable to combine intermediate data assigned a common partition;
a modified spill module operable to move intermediate data from a buffer filled to a threshold limit;
a compression module operable to compress intermediate data,
a merge module operable to merge multiple files of intermediate data moved from the buffer; and
a transfer module operable to make intermediate data organized by partitions available to corresponding reducers at additional computing nodes in the cluster; and
the temporary file system operable to provide, at a speed enabled by the memory, the file-system information about the intermediate data used to enable at least one shuffle operation undertaken by the at least one of the partition module, the sort module, the combine module, the modified spill module, the compression module, the merge module, and the transfer module.

8. The system of claim 1, wherein the mapper, the memory, and the temporary file system are assigned to a virtual computing node supported by a virtual computing environment within the cluster.

9. A method for enhancing shuffling operations on intermediate data generated by distributed, parallel processing comprising:
maintaining, in memory of a computing node, a temporary file system for intermediate data produced at the computing node during distributed, parallel processing by a cluster of computing nodes; and
providing metadata about the intermediate data to the temporary file system.

10. The method of claim 9 further comprising referencing the temporary file system to support at least one intermediate operation implemented by the distributed, parallel processing at a speed consistent with the memory maintaining the temporary file system.

11. The method of claim 9 further comprising moving intermediate data from a buffer to a cache maintained by the memory of the computing node for temporary accessibility, avoiding delays associated with persistent storage.

12. The method of claim 11 further comprising:
receiving, from a client device and by the cluster of computing nodes, a processing job;
splitting, at a master computing node in the cluster, the processing job into multiple smaller jobs that reduce the potential for maxing out the cache and for one or more writes of intermediate data into persistent storage for a smaller job from the multiple smaller jobs.

13. The method of claim 11 further comprising a backend storing the intermediate data remotely on at least one of a cloud service and a Storage Area Network (SAN) communicatively coupled to the computing node by an internet Small Computer System Interface (iSCSI).

14. A system for reducing latency in a shuffle phase of MapReduce data processing comprising:
a slave node within a cluster of nodes, the cluster operable to perform MapReduce data processing;
a data node residing at the slave node and comprising at least one storage device operable to provide persistent storage for a block of input data for MapReduce data processing, input data being distributed across the cluster in accordance with a disturbed file system;
a mapper residing at the slave node and operable to apply a map function to the block of input data resulting in shuffle data;
Random Access Memory (RAM) supporting computation at the slave node; and
a shuffle file system operable to be maintained at the memory, to provide file-system services for the shuffle data, and to receive metadata for the shuffle data.

15. The system of claim 14 further comprising a modified spill module operable to provide metadata devoted to the shuffle data in categories limited to information utilized by at least one predetermined shuffle operation implemented by the MapReduce data processing.

16. The system of claim 14 further comprising at least one module operable to perform an operation consistent with a shuffle phase of the MapReduce data processing, at least in part, by accessing the shuffle file system.

17. The system of claim 14 further comprising backend storage operable to store the shuffle data remotely in at least one of a cloud service and a Storage Area Network (SAN), the SAN linked to the slave node by an internet Small Computer System Interface (iSCSI).

18. The system of claim 14 further comprising:
a buffer reserved in the memory to receive shuffle data from the mapper;
a page cache also apportioned from the memory and operable to receive shuffle data from the buffer, avoiding latencies otherwise introduced for shuffle-phase execution by accessing shuffle data stored in persistent storage.
a modified spill module operable to copy shuffle data, as a buffer limit is reached, from the buffer to the page cache for temporary maintenance and rapid access.

19. The system of claim 14 further comprising:
a master node in the cluster;
a job store maintained by the master node and operable to receive jobs, from a client device, for MapReduce data processing in the cluster; and
a job-sizing module operable to at least one of:
increase a number of nodes in the cluster processing a given job in the job store to increase a probability that shuffle data generated by the node does not exceed a threshold value for a page cache maintained by the node; and
split a job to increase a probability that shuffle data generated by the node in the cluster does not exceed a threshold value for a page cache maintained by the node.

20. The system of claim 14 further comprising:
a buffer reserved in the memory to receive shuffle data from the mapper;
a modified spill module operable to:
move buffered shuffle data from the buffer to another location upon fulfillment of a buffer limit; and
provide metadata devoted to the buffered shuffle data to the shuffle file system.
